(19) United States
(12) Patent Application Publication
(10) Pub. No.: US 2013/0185037 A1
(43) Pub. Date: Jul. 18, 2013

(54) System for Modelling the Conversion of Lignocellulosic Materials

(71) Applicants: Willem Heber Van Zyl, Stellenbosch (ZA); Josebus Maree Van Zyl, Stellenbosch (ZA); Thomas Michael Harms, Stellenbosch (ZA); Engene Van Rensburg, Tyger Waterfront (ZA); Lee Rybeck Lynd, Meriden, NH (US)

(72) Inventors: Willem Heber Van Zyl, Stellenbosch (ZA); Josebus Maree Van Zyl, Stellenbosch (ZA); Thomas Michael Harms, Stellenbosch (ZA); Engene Van Rensburg, Tyger Waterfront (ZA); Lee Rybeck Lynd, Meriden, NH (US)

(73) Assignee: STELLENBOSCH UNIVERSITY, Stellenbosch (ZA)

(21) Appl. No.: 13/808,592

(22) PCT Filed: Jul. 8, 2011
(86) PCT No.: PCT/IB11/01590

§ 371 Date: Apr. 3, 2013

(30) Foreign Application Priority Data
Jul. 9, 2010 (ZA) 2010/04837

(51) Int. Cl. G06F 19/00

(52) U.S. Cl. CPC G06F 19/702
USPC 703/2

(57) ABSTRACT

A system for modelling the conversion of crystalline insoluble cellulose to ethanol is provided which includes a processor configured to calculate the production rate for ethanol based on a number of inputs and as a function of specific equations. The system can form part of a control system for controlling the operation of a plant which produces ethanol from cellulose.

### FIELD OF THE INVENTION

This invention relates to a system for modelling the conversion of lignocellulosic materials. More particularly, the invention relates to a system for modelling crystalline cellulose hydrolysis via the activity of cellulase enzymes to release monomeric sugars.

### BACKGROUND TO THE INVENTION

Approximately 1.3×10¹⁰ metric tons (dry weight) of terrestrial plants are produced annually on a worldwide basis. Plant biomass consists of about 40% to 55% cellulose, 25% to 50% hemicellulose and 10% to 40% lignin, depending on whether the source is hardwood, softwood, or grasses. Cellulose is the major polysaccharide present, and is a water-insoluble glucan polymer that contains the major fraction of the fermentable sugar glucose.

Native cellulose consists of amorphous and crystalline regions and it is predominantly the former region that is prone to enzymatic attack. The major types of enzymatic activities required for native cellulose degradation are: endoglucanases, exoglucanases, cellobiohydrolases and β-glucosidases.

Endoglucanases randomly hydrolyses the cellulose polysaccharide chains in amorphous regions, generating oligosaccharides of varying lengths. Exoglucanases act in a processive manner on the reducing or non-reducing ends of these chains, liberating either glucose (glucanohydrolases) or cellobiose (cellobiohydrolase) as the major products. Exoglucanases can also act on microcrystalline cellulose, presumably peeling cellulose chains from the microcrystalline structure. β-Glucosidase enzymes hydrolyse soluble cellobiose to glucose units.

A variety of plant biomass resources are available as lignocellulosic feedstocks for the production of biofuels, notably bioethanol. The major sources are (i) wood residues from paper mills, sawmills and furniture manufacturing, (ii) municipal solid wastes, (iii) agricultural residues and (iv) energy crops. Pre-conversion of particularly the cellulosic fraction in these biomass resources (using either physical, chemical or enzymatic processes) to fermentable sugars (glucose and cellobiose) would enable their fermentation to bioethanol, provided the necessary fermentative micro-organisms with the ability to utilize these sugars are present.

Saccharomyces cerevisiae (Bakers' yeast) remains the preferred micro-organism for the production of ethanol. Attributes in favour of the use of this microbe include (i) high ethanol productivity approaching the theoretical ethanol yield (0.51 g ethanol produced/g glucose used), (ii) high osmo- and ethanol tolerance, (iii) natural robustness in industrial processes, (iv) being generally regarded as safe due to its long association with wine and bread making, and beer brewing. The major shortcoming of S. cerevisiae lies in its inability to utilize complex polysaccharides such as cellulose and the associated break-down products cellobiose and other cellodextrins. Therefore enzymes are added to break these complex polysaccharides down to simple sugars such as glucose which are easily fermented allowing for the simultaneous saccharification and fermentation (SSF) of the cellulose.

In an attempt to understand and predict SSF of cellulose, various numerical models have been proposed to describe the complex enzyme kinetics responsible for the hydrolysis of cellulose to sugar (Converse et al. 1988, Gusakov and Sinitsyn 1985, Scheiding et al. 1984, Caminal et al. 1985, Converse and Optekar 1993). However, limited literature exists on modelling complete SSF of cellulosic materials incorporating a fermentative yeast and exogenuously added cellulolytic enzymes.

South et al. (1995) proposed a model for the SSF of two pretreated hardwoods, namely birch and poplar. He assumed a Langmuir adsorption-type behaviour for the substrate-enzyme interactions and proposed a diminishing substrate conversion rate of the form

$${r}_{c} = ( {k ( 1 - x )}^{n} + c ) \times \frac{EC}{1 + {σ}_{c}}$$

as a function of conversion (x) and enzyme occupied active sites (EC) where k, n and c are empirical constants and σ_{c} the adsorption capacity of enzyme to the substrate. Shao et al. (2008) and Zhang et al. (2009) proposed similar models for paper sludge using dynamic adsorption. Parameters for adsorption and substrate conversion rates for these models were determined empirically from experimental measurements. The remaining rate equations and parameters describing the conversion of cellobiose to glucose and subsequent fermentation of glucose to ethanol were obtained from literature.

These models are, however, not very accurate, particularly as far as other heterogeneous/particulate cellulose sources are concerned. Also, being empirical models their usefulness tends to be limited, especially when scaling up reactions to commercial plant size.

Another factor which affects the scale up of chemical processes is the mixing conditions under which they occur. Most chemical reactor designs are based on the assumption that all components in the reactors are perfectly mixed. However in biological systems, the amount of mixing is limited by secondary conditions such as shear rate which could potentially be fatal to the organisms involved. Thus there exist a risk of incomplete mixing, which may result in the settling of particles out of suspension significantly reducing the efficiency and thus performance of these systems.

### OBJECT OF THE INVENTION

It is an object of this invention to provide a system for modelling the conversion of lignocellulosic material which will, at least partially, alleviate some of the above-mentioned problems.

### SUMMARY OF THE INVENTION

In accordance with this invention there is provided a system for modelling the conversion of crystalline insoluble cellulose to ethanol which includes a processor configured to calculate the production rate for ethanol based on the following inputs:
Yeast cell concentration [g/L]-([X])
Cellulose concentration [g/L]-([C])
Cellobiose concentration [g/L]-([Cb])
Exo-cellulase enzyme concentration [g/L]-([Eₑₓₒ])
Endo-cellulase enzyme concentration [g/L]-([E_{endo}])
β-Glucosidase concentration [g/L]-([B])
Cellulose-enzyme complex concentration [g/L]-([EC]ₑₓₒ)
Cellulose-enzyme complex concentration [g/L]-([EC]_{endo})
Ethanol concentration [g/L]-([Eth])
Carbon Dioxide concentration [g/L]-([CO₂])
Glycerol concentration [g/L]-([Gly])
Glucose concentration [g/L]-([G])
   and as a function of the following equations:

$$\begin{matrix} [ {E}_{f} ] = [ {E}_{T} ] - \frac{[ EC ] \times σ}{( 1 + σ )} & ( 1 ) \\ [ {C}_{f} ] = [ {C}_{T} ] - \frac{[ EC ]}{( 1 + σ )} & ( 2 ) \\ \frac{d {[ EC ]}_{endo}}{d t} = \frac{d {[ C ]}_{endo}}{d t} \times ( 1 + {σ}_{endo} ) + {k}_{fc} [ {E}_{f , endo} ] [ {C}_{f , endo} ] ( 1 + {σ}_{endo} ) - {\frac{{k}_{fc}}{{K}_{endo}} [ EC ]}_{endo} & ( 3 ) \\ \frac{d {[ EC ]}_{exo}}{d t} = \frac{d {[ C ]}_{exo}}{d t} \times ( 1 + {σ}_{exo} ) + {k}_{fc} [ {E}_{f , exo} ] [ {C}_{f , exo} ] ( 1 + {σ}_{exo} ) - {\frac{{k}_{fc}}{{K}_{exo}} [ EC ]}_{exo} & ( 4 ) \\ \frac{d {[ C ]}_{endo}}{d t} = - {k}_{endo} \times \frac{{[ EC ]}_{endo}}{1 + {σ}_{endo}} \times ( \frac{{K}_{C \_ Cb}}{[ Cb ] + {K}_{C \_ Cb}} ) \times ( \frac{{K}_{C \_ Eth}}{[ Eth ] + {K}_{C \_ Eth}} ) & ( 5 ) \\ \frac{d {[ C ]}_{exo}}{d t} = tanh ( \frac{t}{τ} ) \times - {k}_{exo} \times \frac{{[ EC ]}_{exo}}{1 + {σ}_{exo}} \times ( \frac{{K}_{C \_ Cb}}{[ Cb ] + {K}_{C \_ Cb}} ) \times ( \frac{{K}_{C \_ Eth}}{[ Eth ] + {K}_{C \_ Eth}} ) & ( 6 ) \\ \frac{d [ Cb ]}{d t} = - \frac{342}{324} \times \frac{d [ C ]}{d t} - \frac{{K}_{Cb} [ Cb ] [ B ]}{{K}_{m} \times ( 1 + \frac{[ G ]}{{K}_{Cb \_ G}} ) + [ Cb ]} & ( 7 ) \\ \frac{d [ G ]}{d t} = ( - \frac{342}{324} \times \frac{d [ C ]}{d t} - \frac{d [ Cb ]}{d t} ) \times \frac{360}{342} - \frac{1}{{Y}_{X \_ G}} \times \frac{d [ X ]}{d t} & ( 8 ) \\ \frac{d [ X ]}{d t} = \frac{{μ}_{ma x} [ X ] [ G ]}{[ G ] + {K}_{G}} \times ( 1 - \frac{[ Eth ]}{{K}_{X \_ Eth}} ) & ( 9 ) \\ \frac{d [ Eth ]}{d t} = ( \frac{{Y}_{Eth \_ G}}{{Y}_{X \_ G}} ) \times \frac{d [ X ]}{d t} & ( 10 ) \\ \frac{d [ {CO}_{2} ]}{d t} = ( \frac{{Y}_{CO 2 \_ G}}{{Y}_{X \_ G}} ) \times \frac{d [ X ]}{d t} & ( 11 ) \\ \frac{d [ Gly ]}{d t} = ( \frac{{Y}_{Gly \_ G}}{{Y}_{X \_ G}} ) \times \frac{d [ X ]}{d t} & ( 12 )\end{matrix}$$

where:
K_{C}_{_{—}}_{Cb}=Inhibition constant of cellobiose on cellulose conversion [g/L]
K_{C}_{_{—}}_{Eth}=Inhibition constant of ethanol on cellulose conversion [g/L]
K_{Cb}=Rate constant for hydrolysis of cellobiose to glucose [g/L]
K_{Cb}_{_{—}}_{G}=Inhibition of hydrolysis of cellobiose by glucose [g/L]
K_{endo}=Equilibrium constant for endoglucanase [L/g]
k_{endo}=Hydrolysis rate constant of endoglucanase [h⁻]
Kₑₓₒ=Equilibrium constant for exoglucanase [L/g]
kₑₓₒ=Hydrolysis rate constant of exoglucanase [h⁻¹]
k_{fc}=Enzyme adsorption constant to Avicel [h⁻¹]
K_{G}=Monod constant [g/L]
Kₘ=Michaelis constant of β-glucosidase for cellobiose [g/L]
K_{X}_{_{—}}_{Eth}=Inhibition of cell growth by ethanol [g/L]
Y_{Eth}_{_{—}}_{G}=Yield of ethanol cells per gram of glucose
Y_{CO2}_{_{—}}_{G}=Yield of ethanol cells per gram of glucose
Y_{Gly}_{_{—}}_{G}=Yield of ethanol cells per gram of glucose
Y_{X}_{_{—}}_{G}=Yield of yeast cells per gram of glucose
μₘₐₓ=Maximum growth rate of yeast cells [h⁻¹]
σ_{endo}=Endoglucanse enzyme capacity on Avicel [dimensionless]
σₑₓₒ=Exoglucanase enzyme capacity on Avicel [dimensionless]
T=Time Constant [h]

Further features of this invention provide for the calculated production rate for ethanol to be used to adjust process parameters; for the processor to solve the equations (1) to (10) iteratively; for the processor to include a feedback loop which includes the further input of a measured rate of formation of enzyme-substrate complexes; and for a still further input to the processor of supplied oxygen to be provided.

A still further feature of the invention provides for the processor to calculate the production rates of carbon dioxide and glycerol based on the following inputs:
Carbon Dioxide concentration [g/L]-([CO₂])
Glycerol concentration [g/L]-([Gly])
   and as a function of the following equations:

$$\begin{matrix}\frac{d [ {CO}_{2} ]}{d t} = ( \frac{{Y}_{CO 2 \_ G}}{{Y}_{X \_ G}} ) \times \frac{d [ X ]}{d t} & ( 11 ) \\ \frac{d [ Gly ]}{d t} = ( \frac{{Y}_{Gly \_ G}}{{Y}_{X \_ G}} ) \times \frac{d [ X ]}{d t} & ( 12 )\end{matrix}$$

where:
Y_{CO2}_{_{—}}_{G}=Yield of ethanol cells per gram of glucose
Y_{Gly}_{_{—}}_{G}=Yield of ethanol cells per gram of glucose
A yet further feature of the invention provides for processor to calculate the rheological properties of a medium in which the conversion of crystalline insoluble cellulose to ethanol occurs, including drag, shear rates and wall shear stress required, based on the following inputs:
Drag Coefficient [Dimensionless]-(C_{D})
Lift coefficient [Dimensionless]-(C_{L})
Effective diameter of the particles [m]-(D_{eff})
Gravitational constant [m/s²]-(g)
Viscosity variable as a function of volume fraction [kg/m·s⁽¹⁻ⁿ⁾]-(K)
Mass of the ethanol component [kg]-(mₑ)
Mass of the glycerol component [kg]-(m_{g})
Total mass of the solution [kg]-(mₜₒₜₐₗ)
Mass of the water component [kg]-(m_{w})
Viscosity power variable as a function of volume fraction-(n)
Absolute temperature [K]-(T)
Molar fraction of ethanol-(xₑ)
Molar fraction of glycerol-(x_{g})
Molar fraction of water-(x_{w})
Volume fraction of the continuous phase-(α_{c})
Volume fraction of the cellulose particles-(αₛ)
Dynamic viscosity of mixture [kg/m·s]-(μ_{eff})
Base dynamic viscosity of the fluid [kg/m·s]-(μₒ)
Dynamic viscosity of base medium [kg/m·s]-(μ_{b})
Continuous medium density [kg/m³]-(ρ_{eff})
Particle density [kg/m³]-(ρₛ)
   and as a function of the following equations:

$$\begin{matrix} \frac{\partial }{\partial t} ( {α}_{i} {ρ}_{i} ) + ∇ \cdot ( {α}_{i} {ρ}_{i} {v}_{i} ) = 0 & ( 13 ) \\ \frac{\partial }{\partial t} ( {α}_{i} {ρ}_{i} {v}_{i} ) + ∇ \cdot ( {α}_{i} {ρ}_{i} {v}_{i} {v}_{i} ) = - {α}_{i} ∇ p + {α}_{i} {ρ}_{i} g + ∇ \cdot [ {α}_{i} ( {τ}_{i} + {τ}_{i}^{t} ) ] + {M}_{i} & ( 14 ) \\ {F}_{L} = {C}_{L} {α}_{s} {ρ}_{c} [ {v}_{r} \times ( ∇ \times {v}_{r} ) ] & ( 15 ) \\ {F}_{c d}^{TD} = ( - {A}_{cs}^{D} ) \frac{{v}_{c}^{t}}{{σ}_{α}} ( \frac{∇ {α}_{s}}{{α}_{s}} - \frac{∇ {α}_{c}}{{α}_{c}} ) & ( 16 ) \\ {F}_{i , s} = - 101325 \{ tanh [ 200 ( {α}_{ma x , s} - {α}_{s} ) ] - 1 \} ∇ {α}_{s} & ( 17 ) \\ {F}_{cs}^{D} = {A}_{cs}^{D} ( {v}_{s} - {v}_{c} ) \\ with \text{:} & ( 18 ) \\ {A}_{cs}^{D} = \frac{3 {α}_{c} {α}_{s} {ρ}_{c} {C}_{D}}{4 {V}_{rs}^{2} {D}_{eff}} \vert {v}_{r} \vert & ( 19 ) \\ {V}_{rs} = 0.5 [ A - 0.06 {Re}_{s} + \sqrt{{( 0.06 {Re}_{s} )}^{2} + 0.12 {Re}_{s} ( 2 B - A ) + {A}^{2}} ] & ( 20 ) \\ {Re}_{s} = \frac{{ρ}_{c} {v}_{τ} {D}_{eff}}{{μ}_{c}} & ( 21 ) \\ A = {α}_{c}^{4.14} & ( 22 ) \\ B = \{ \begin{matrix}0.8 {α}_{c}^{1.28} ; & {α}_{c} < {α}_{tr} \\ {α}_{c}^{2.65} ; & {α}_{c} \geq {α}_{tr}\end{matrix} & ( 23 ) \\ {C}_{D} = \frac{24}{{Re}_{s}} + \frac{6}{1 + \sqrt{{Re}_{s}}} + 0.4 \\ and & ( 24 ) \\ {μ}_{eff} = ( 1 - {α}_{s} ) {μ}_{0} + ( {α}_{s} ) {μ}_{s} \\ with \text{:} & ( 25 ) \\ {μ}_{0} = \{ {v}_{e / w} + a ⌊ exp ( {bx}_{g} ) - 1 ⌋ \} {p}_{eff} \\ with & ( 26 ) \\ {v}_{e / w} = {x}_{e} {v}_{e} + ( 1 - {x}_{e} ) {v}_{w} + {x}_{e} ( 1 - {x}_{e} ) {F}_{T} & ( 27 ) \\ {F}_{T} = [ \begin{matrix}exp ( \frac{3255}{T} - 9.41 ) + ( 1 - 2 {x}_{e} ) exp ( \frac{3917}{T} - 11.44 ) + \\ {( 1 - 2 {x}_{e} )}^{2} exp ( \frac{5113}{T} - 16.6 )\end{matrix} ] & ( 28 ) \\ a = - 1.39 + 5.64 exp ( \frac{273.1 - T}{62.03} ) + [ 3.56 - \frac{89.18}{{( T - 273.1 )}^{1.5}} ] {x}_{e} - 8.80 {x}_{e}^{2} + 5.91 {x}_{e}^{3} & ( 29 ) \\ b = 4.11 + 5.54 exp ( \frac{273.1 - T}{25.03} ) & ( 30 ) \\ {ρ}_{eff} = \frac{{m}_{w} \times {ρ}_{w} + {m}_{e} + {m}_{g} \times {ρ}_{G}}{{m}_{total}} & ( 31 ) \\ {μ}_{s} = K {\dot{γ}}^{n} & ( 32 ) \\ K = \{ \begin{matrix}\frac{201 ( {α}_{s} - 0.0125 )}{[ 1 + 49 ( {α}_{s} - 0.0125 ) ]} ; & for {α}_{s} > 0.0125 \\ 0 ; & for {α}_{s} \leq 0.0125\end{matrix} & ( 33 ) \\ n = - 2.764 {α}_{s} - 0.631 & ( 34 )\end{matrix}$$

where:

### F_{cs}^{D}=Drag Force [N/m³]

Mᵢ=Source terms [N/m³]
p=Pressure [Pa]
Reₛ=Reynolds number
V_{P,term}=Terminal settling velocity of the particles [m/s]
v_{c}=Velocity vector of the continuous phase [m/s]
vᵢ=Velocity vector of species [m/s]
vᵣ=Relative velocity vector [m/s]
vₛ=Velocity vector of the solids [m/s]
α_{c}=Volume fraction of the continuous phase
αᵢ=Volume fraction of the species
αₛ=Volume fraction of the cellulose particles
αₜᵣ=Volume fraction at which drag model transition occurs
μ=Dynamic viscosity of mixture [kg/m·s]
μₒ=Base dynamic viscosity of the fluid [kg/m·s]
μₛ=Dynamic viscosity adjustment for solids concentration [kg/m·s]
ρ_{c}=Density of continuous phase [kg/m³]
ρₑ=Density of ethanol [kg/m³]
ρ_{g}=Density of glycerol [kg/m³]
ρᵢ=Density of each species [kg/m³]
ρₚ=Particle density [kg/m³]
ρ_{w}=Density of water [kg/m³]
vₑ=Kinematic viscosity of ethanol [m²/s]
v=Kinematic viscosity of the aqueous ethanol-glycerol [m²/s]
v_{e/w}=Kinematic viscosity of the binary aqueous ethanol [m²/s]
v_{w}=Kinematic viscosity of water [m²/s]
τᵢ=Shear stress of species [N/m²]
\dot{γ}=Shear-rate [s⁻¹]
τᵢ^{t}=Turbulent shear stress of species [N/m²]
v_{c}^{t}=Turbulent kinematic viscosity of continuous phase [m²/s]
σ_{α}=Turbulent Prandtl number

The invention also provides for a control system for a biofuels plant characterised in that it includes a processor substantially as defined above and which further includes means for controlling at least some operations of the plant to achieve user determined ethanol production rates based on measurements made within the plant.

Further features of the invention provide for supplied oxygen to be used in the calculation.

The invention still further provides a method of calculating the production rate of ethanol in a process which converts crystalline insoluble cellulose to ethanol, which includes iteratively solving the following equations:

$$\begin{matrix} [ {E}_{f} ] = [ {E}_{T} ] - \frac{[ EC ] \times σ}{( 1 + σ )} & ( 1 ) \\ [ {C}_{f} ] = [ {C}_{T} ] - \frac{[ EC ]}{( 1 + σ )} & ( 2 ) \\ \frac{d {[ EC ]}_{endo}}{d t} = \frac{d {[ C ]}_{endo}}{d t} \times ( 1 + {σ}_{endo} ) + {k}_{fc} [ {E}_{f , endo} ] [ {C}_{f , endo} ] ( 1 + {σ}_{endo} ) - {\frac{{k}_{f c}}{{K}_{endo} } [ EC ]}_{endo} & ( 3 ) \\ \frac{d {[ EC ]}_{exo}}{d t} = \frac{d {[ C ]}_{exo}}{d t} \times ( 1 + {σ}_{exo} ) + {k}_{fc} [ {E}_{f , exo} ] [ {C}_{f , exo} ] ( 1 + {σ}_{exo} ) - {\frac{{k}_{fc}}{{K}_{exo}} [ EC ]}_{exo} & ( 4 ) \\ \frac{d {[ C ]}_{endo}}{d t} = - {k}_{endo} \times \frac{{[ EC ]}_{endo}}{1 + {σ}_{endo}} \times ( \frac{{K}_{C \_ Cb}}{[ Cb ] + {K}_{C \_ Cb}} ) \times ( \frac{{K}_{C \_ Eth}}{[ Eth ] + {K}_{C \_ Eth}} ) & ( 5 ) \\ \frac{d {[ C ]}_{exo}}{d t} = tanh ( \frac{t}{τ} ) \times - {k}_{exo} \times \frac{{[ EC ]}_{exo}}{1 + {σ}_{exo}} \times ( \frac{{K}_{C \_ Cb}}{[ Cb ] + {K}_{C \_ Cb}} ) \times ( \frac{{K}_{C \_ Eth}}{[ Eth ] + {K}_{C \_ Eth}} ) & ( 6 ) \\ \frac{d [ Cb ]}{d t} = - \frac{342}{324} \times \frac{d [ C ]}{d t} - \frac{{K}_{Cb} [ Cb ] [ B ]}{{K}_{m} \times ( 1 + \frac{[ G ]}{{K}_{Cb \_ G}} ) + [ Cb ]} & ( 7 ) \\ \frac{d [ G ]}{d t} = ( - \frac{342}{324} \times \frac{d [ C ]}{d t} - \frac{d [ Cb ]}{d t} ) \times \frac{360}{342} - \frac{1}{{Y}_{X \_ G}} \times \frac{d [ X ]}{d t} & ( 8 ) \\ \frac{d [ X ]}{d t} = \frac{{μ}_{ma x} [ X ] [ G ]}{[ G ] + {K}_{G}} \times ( 1 - \frac{[ Eth ]}{{K}_{X \_ Eth}} ) & ( 9 ) \\ \frac{d [ Eth ]}{d t} = ( \frac{{Y}_{Eth \_ G}}{{Y}_{X \_ G}} ) \times \frac{d [ X ]}{d t} & ( 10 )\end{matrix}$$

where:
K_{C}_{_{—}}_{Cb}=Inhibition constant of cellobiose on cellulose conversion [g/L]
K_{C}_{_{—}}_{Eth}=Inhibition constant of ethanol on cellulose conversion [g/L]
K_{Cb}=Rate constant for hydrolysis of cellobiose to glucose [g/L]
K_{Cb}_{_{—}}_{G}=Inhibition of hydrolysis of cellobiose by glucose [g/L]
K_{endo}=Equilibrium constant for endoglucanase [L/g]
k_{endo}=Hydrolysis rate constant of endoglucanase [h⁻¹]
Kₑₓₒ=Equilibrium constant for exoglucanase [L/g]
kₑₓₒ=Hydrolysis rate constant of exoglucanase [h⁻¹]
k_{fc}=Enzyme adsorption constant to Avicel [h⁻¹]
K_{G}=Monod constant [g/L]
Kₘ=Michaelis constant of β-glucosidase for cellobiose [g/L]
K_{X}_{_{—}}_{Eth}=Inhibition of cell growth by ethanol [g/L]
Y_{Eth}_{_{—}}_{G}=Yield of ethanol cells per gram of glucose
Y_{X}_{_{—}}_{G}=Yield of yeast cells per gram of glucose
μₘₐₓ=Maximum growth rate of yeast cells [h⁻¹]
σ_{endo}=Endoglucanse enzyme capacity on Avicel [dimensionless]
σₑₓₒ=Exoglucanase enzyme capacity on Avicel [dimensionless]
T=Time Constant [h]
   based on measurements of the following variables:
Yeast cell concentration [g/L]-([X])
Cellulose concentration [g/L]-([C])
Cellobiose concentration [g/L]-([Cb])
Exo-cellulase enzyme concentration [g/L]-([Eₑₓₒ])
Endo-cellulase enzyme concentration [g/L]-([E_{endo}])
β-Glucosidase concentration [g/L]-([B])
Cellulose-enzyme complex concentration [g/L]-([EC]ₑₓₒ)
Cellulose-enzyme complex concentration [g/L]-([EC]_{endo})
Ethanol concentration [g/L]-([Eth])
Glucose concentration [g/L]-([G])
   A further feature of the invention provides for the production rate of glycerol and carbon dioxide are simultaneously calculated as a function of the following equations:
Carbon Dioxide concentration [g/L]-([CO₂])
Glycerol concentration [g/L]-([Gly])

$$\begin{matrix}\frac{d [ {CO}_{2} ]}{d t} = ( \frac{{Y}_{CO 2 \_ G}}{{Y}_{X \_ G}} ) \times \frac{d [ X ]}{d t} & ( 11 ) \\ \frac{d [ Gly ]}{d t} = ( \frac{{Y}_{Gly \_ G}}{{Y}_{ X \_ G}} ) \times \frac{d [ X ]}{d t} & ( 12 )\end{matrix}$$

where:
Y_{CO2}_{_{—}}_{G}=Yield of ethanol cells per gram of glucose
Y_{Gly}_{_{—}}_{G}=Yield of ethanol cells per gram of glucose

### BRIEF DESCRIPTION OF THE DRAWINGS

In the drawings:

FIG. 1 is a plot of concentration [g/L] (y-axis) in against time [h] (x-axis) for the experimental and simulated data for glucose, ethanol, glycerol and biomass;

FIG. 2 is a plot of protein concentration [g/L] (y-axis) in against time [h] (x-axis) for the calculated added and free enzymes in solution for endoglucanase and exoglucanase;

FIG. 3 is a plot of protein concentration [g/L] (y-axis) in against time [h] (x-axis) for the calculated and simulated adsorbed enzymes in solution for endoglucanase and exoglucanase;

FIG. 4 is a plot of concentration [g/L] (y-axis) in against time [h] (x-axis) for the experimental and simulated data for Avicel, glucose, ethanol, glycerol and biomass; and

FIG. 5 shows the dynamic viscosity for Avicel particles in water with the error-bars representing the standard deviation of each measurement.

### DETAILED DESCRIPTION WITH REFERENCE TO THE DRAWINGS

A system is provided for modelling the conversion of crystalline insoluble cellulose to ethanol and includes a processor configured, in this embodiment through software, to calculate the production rate for ethanol. The processor requires the following inputs which can be entered by an operator or determined by suitable measuring devices and provided automatically to the processor:
Yeast cell concentration [g/L]-([X])
Cellulose concentration [g/L]-([C])
Cellobiose concentration [g/L]-([Cb])
Exo-cellulase enzyme concentration [g/L]-([Eₑₓₒ])
Endo-cellulase enzyme concentration [g/L]-([E_{endo}])
β-Glucosidase concentration [g/L]-([B])
Cellulose-enzyme complex concentration [g/L]-([EC]ₑₓₒ)
Cellulose-enzyme complex concentration [g/L]-([EC]_{endo})
Ethanol concentration [g/L]-([Eth])
Carbon Dioxide concentration [g/L]-([CO₂])
Glycerol concentration [g/L]-([Gly])
Glucose concentration [g/L]-([G])
   Using these inputs, ethanol production, as well as the rate of carbon dioxide and glycerol formation, is calculated as a function of the following equations which are solved iteratively:

$$\begin{matrix} [ {E}_{f} ] = [ {E}_{T} ] - \frac{[ EC ] \times σ}{( 1 + σ )} & ( 1 ) \\ [ {C}_{f} ] = [ {C}_{T} ] - \frac{[ EC ]}{( 1 + σ )} & ( 2 ) \\ \frac{d {[ EC ]}_{endo}}{d t} = \frac{d {[ C ]}_{endo}}{d t} \times ( 1 + {σ}_{endo} ) + {k}_{fc} [ {E}_{f , endo} ] [ {C}_{f , endo} ] ( 1 + {σ}_{endo} ) - {\frac{{k}_{fc}}{{K}_{endo}} [ EC ]}_{endo} & ( 3 ) \\ \frac{d {[ EC ]}_{exo}}{d t} = \frac{d {[ C ]}_{exo}}{d t} \times ( 1 + {σ}_{exo} ) + {k}_{fc} [ {E}_{f , exo} ] [ {C}_{f , exo} ] ( 1 + {σ}_{exo} ) - {\frac{{k}_{fc}}{{K}_{exo}} [ EC ]}_{exo} & ( 4 ) \\ \frac{d {[ C ]}_{endo}}{d t} = - {k}_{endo} \times \frac{{[ EC ]}_{endo}}{1 + {σ}_{endo}} \times ( \frac{{K}_{C \_ Cb}}{[ Cb ] + {K}_{C \_ Cb}} ) \times ( \frac{{K}_{C \_ Eth}}{[ Eth ] + {K}_{C \_ Eth}} ) & ( 5 ) \\ \frac{d {[ C ]}_{exo}}{d t} = tanh ( \frac{t}{τ} ) \times - {k}_{exo} \times \frac{{[ EC ]}_{exo}}{1 + {σ}_{exo}} \times ( \frac{{K}_{C \_ Cb}}{[ Cb ] + {K}_{C \_ Cb}} ) \times ( \frac{{K}_{C \_ Eth}}{[ Eth ] + {K}_{C \_ Eth}} ) & ( 6 ) \\ \frac{d [ Cb ]}{d t} = - \frac{342}{324} \times \frac{d [ C ]}{d t} - \frac{{K}_{Cb} [ Cb ] [ B ]}{{K}_{m} \times ( 1 + \frac{[ G ]}{{K}_{Cb \_ G}} ) + [ Cb ]} & ( 7 ) \\ \frac{d [ G ]}{d t} = ( - \frac{342}{324} \times \frac{d [ C ]}{d t} - \frac{d [ Cb ]}{d t} ) \times \frac{360}{342} - \frac{1}{{Y}_{X \_ G}} \times \frac{d [ X ]}{d t} & ( 8 ) \\ \frac{d [ X ]}{d t} = \frac{{μ}_{ma x} [ X ] [ G ]}{[ G ] + {K}_{G}} \times ( 1 - \frac{[ Eth ]}{{K}_{X \_ Eth}} ) & ( 9 ) \\ \frac{d [ Eth ]}{d t} = ( \frac{{Y}_{Eth \_ G}}{{Y}_{X \_ G}} ) \times \frac{d [ X ]}{d t} & ( 10 ) \\ \frac{d [ {CO}_{2} ]}{d t} = ( \frac{{Y}_{CO 2 \_ G}}{{Y}_{X \_ G}} ) \times \frac{d [ X ]}{d t} & ( 11 ) \\ \frac{d [ Gly ]}{d t} = ( \frac{{Y}_{Gly \_ G}}{{Y}_{X \_ G}} ) \times \frac{d [ X ]}{d t} & ( 12 )\end{matrix}$$

### Where:

K_{C}_{_{—}}_{Cb}=Inhibition constant of cellobiose on cellulose conversion [g/L]
K_{C}_{_{—}}_{Eth}=Inhibition constant of ethanol on cellulose conversion [g/L]
K_{Cb}=Rate constant for hydrolysis of cellobiose to glucose [g/L]
K_{Cb}_{_{—}}_{G}=Inhibition of hydrolysis of cellobiose by glucose [g/L]
K_{endo}=Equilibrium constant for endoglucanase [L/g]
k_{endo}=Hydrolysis rate constant of endoglucanase [h⁻¹]
Kₑₓₒ=Equilibrium constant for exoglucanase [L/g]
kₑₓₒ=Hydrolysis rate constant of exoglucanase [h⁻¹]
k_{fc}=Enzyme adsorption constant to Avicel [h⁻¹]
K_{G}=Monod constant [g/L]
Kₘ=Michaelis constant of β-glucosidase for cellobiose [g/L]
K_{X}_{_{—}}_{Eth}=Inhibition of cell growth by ethanol [g/L]
Y_{Eth}_{_{—}}_{G}=Yield of ethanol cells per gram of glucose
Y_{CO2}_{_{—}}_{G}=Yield of ethanol cells per gram of glucose
Y_{Cly}_{_{—}}_{D}=Yield of ethanol cells per gram of glucose
Y_{X}_{_{—}}_{G}=Yield of yeast cells per gram of glucose
μₘₐₓ=Maximum growth rate of yeast cells [h⁻]
σ_{endo}=Endoglucanse enzyme capacity on Avicel [dimensionless]
σₑₓₒ=Exoglucanase enzyme capacity on Avicel [dimensionless]
T=Time Constant [h]

The calculated rate of ethanol production can be used to predict process results from and, importantly, also to adjust process parameters to ensure that optimum efficiencies are achieved.

The processor will preferably have a feedback loop which includes further inputs, particularly that of a measured rate of formation of enzyme-substrate complexes and of supplied oxygen, and iteratively models the process based on additional inputs.

The processor will preferably also calculate the rheological properties of the medium in which the conversion of the cellulose takes place. This includes drag, shear rates and wall shear stress and flow fields required from fundamental computational fluid dynamics equations and inputs from the system including but not limited to

### Inputs:

Drag Coefficient [Dimensionless]-(C_{D})
Lift coefficient [Dimensionless]-(C_{L})
Effective diameter of the particles [m]-(D_{eff})
Gravitational constant [m/s²]-(g)
Viscosity variable as a function of volume fraction [kg/m·s⁽¹⁻ⁿ⁾]-(K)
Mass of the ethanol component [kg]-(mₑ)
Mass of the glycerol component [kg]-(m_{g})
Total mass of the solution [kg]-(mₜₒₜₐₗ)
Mass of the water component [kg]-(m_{w})
Viscosity power variable as a function of volume fraction-(n)
Absolute temperature [K]-(T)
Molar fraction of ethanol-(xₑ)
Molar fraction of glycerol-(x_{g})
Molar fraction of water-(x_{w})
Volume fraction of the continuous phase-(α_{c})
Volume fraction of the cellulose particles-(αₛ)
Dynamic viscosity of mixture [kg/m·s]-(μ_{eff})
Base dynamic viscosity of the fluid [kg/m·s]-(μₒ)
Dynamic viscosity of base medium [kg/m·s]-(μ_{b})
Continuous medium density [kg/m³]-(ρ_{eff})
Particle density [kg/m³]-(ρₛ)
   As a function of the following equations:

$$\begin{matrix} \frac{\partial }{\partial t} ( {α}_{i} {ρ}_{i} ) + ∇ \cdot ( {α}_{i} {ρ}_{i} {v}_{i} ) = 0 & ( 13 ) \\ \frac{\partial }{\partial t} ( {α}_{i} {ρ}_{i} {v}_{i} ) + ∇ \cdot ( {α}_{i} {ρ}_{i} {v}_{i} {v}_{i} ) = - {α}_{i} ∇ p + {α}_{i} {ρ}_{i} g + ∇ \cdot [ {α}_{i} ( {τ}_{i} + {τ}_{i}^{t} ) ] + {M}_{i} & ( 14 ) \\ {F}_{L} = {C}_{L} {α}_{s} {ρ}_{c} [ {v}_{r} \times ( ∇ \times {v}_{r} ) ] & ( 15 ) \\ {F}_{c d}^{TD} = ( - {A}_{cs}^{D} ) \frac{{v}_{c}^{t}}{{σ}_{α}} ( \frac{∇ {α}_{s}}{{α}_{s}} - \frac{∇ {α}_{c}}{{α}_{c}} ) & ( 16 ) \\ {F}_{i , s} = - 101325 \{ tanh [ 200 ( {α}_{ma x , s} - {α}_{s} ) ] - 1 \} ∇ {α}_{s} & ( 17 ) \\ {F}_{cs}^{D} = {A}_{cs}^{D} ( {v}_{s} - {v}_{c} ) \\ with \text{:} & ( 18 ) \\ {A}_{cs}^{D} = \frac{3 {α}_{c} {α}_{s} {ρ}_{c} {C}_{D}}{4 {V}_{rs}^{2} {D}_{eff}} \vert {v}_{r} \vert & ( 19 ) \\ {V}_{rs} = 0.5 [ A - 0.06 {Re}_{s} + \sqrt{{( 0.06 {Re}_{s} )}^{2} 0.12 {Re}_{s} ( 2 B - A ) + {A}^{2}} ] & ( 20 ) \\ {Re}_{s} = \frac{{ρ}_{c} {v}_{r} {D}_{eff}}{{μ}_{c}} & ( 21 ) \\ A = {α}_{c}^{4.14} & ( 22 ) \\ B = \{ \begin{matrix}0.8 {α}_{c}^{1.28} ; & {α}_{c} < {α}_{tr} \\ {α}_{c}^{2.65} ; & {α}_{c} \geq {α}_{tr}\end{matrix} & ( 23 ) \\ {C}_{D} = \frac{24}{{Re}_{s}} + \frac{6}{1 + \sqrt{{Re}_{s}}} + 0.4 \\ and & ( 24 ) \\ {μ}_{eff} = ( 1 - {α}_{s} ) {μ}_{0} + ( {α}_{s} ) {μ}_{s} \\ with \text{:} & ( 25 ) \\ {μ}_{0} = \{ {v}_{e / w} + a ⌊ exp ( {bx}_{g} ) - 1 ⌋ \} {p}_{eff} \\ with & ( 26 ) \\ {v}_{e / w} = {x}_{e} {v}_{e} + ( 1 - {x}_{e} ) {v}_{w} + {x}_{e} ( 1 - {x}_{e} ) {F}_{T} & ( 27 ) \\ {F}_{T} = [ \begin{matrix}exp ( \frac{3255}{T} - 9.41 ) + ( 1 - 2 {x}_{e} ) exp ( \frac{3917}{T} - 11.44 ) + \\ {( 1 - 2 {x}_{e} )}^{2} exp ( \frac{5113}{T} - 16.6 )\end{matrix} ] & ( 28 ) \\ a = - 1.39 + 5.64 exp ( \frac{273.1 - T}{62.03} ) + [ 3.56 - \frac{89.18}{{( T - 273.1 )}^{1.5}} ] {x}_{e} - 8.80 {x}_{e}^{2} + 5.91 {x}_{e}^{3} & ( 29 ) \\ b = 4.11 + 5.54 exp ( \frac{273.1 - T}{25.03} ) & ( 30 ) \\ {ρ}_{eff} = \frac{{m}_{w} \times {ρ}_{w} + {m}_{e} \times {ρ}_{e} + {m}_{g} \times {ρ}_{g}}{{m}_{total}} & ( 31 ) \\ {μ}_{s} = K {\dot{γ}}^{n} & ( 32 ) \\ K = \{ \begin{matrix}\frac{201 ( {α}_{s} - 0.0125 )}{[ 1 + 49 ( {α}_{s} - 0.0125 ) ]} ; & for {α}_{s} > 0.0125 \\ 0 ; & for {α}_{s} \leq 0.0125\end{matrix} & ( 33 ) \\ n = - 2.764 {α}_{s} - 0.631 & ( 34 )\end{matrix}$$

where:

### F_{cs}^{D}=Drag Force [N/m³]

Mᵢ=Source terms [N/m³]
p=Pressure [Pa]
Reₛ=Reynolds number
V_{P,term}=Terminal settling velocity of the particles [m/s]
v_{c}=Velocity vector of the continuous phase [m/s]
vᵢ=Velocity vector of species [m/s]
vᵣ=Relative velocity vector [m/s]
vₛ=Velocity vector of the solids [m/s]
α_{c}=Volume fraction of the continuous phase
αᵢ=Volume fraction of the species
αₛ=Volume fraction of the cellulose particles
αₜᵣ=Volume fraction at which drag model transition occurs
μ=Dynamic viscosity of mixture [kg/m·s]
μₒ=Base dynamic viscosity of the fluid [kg/m·s]
μₛ=Dynamic viscosity adjustment for solids concentration [kg/m·s]
ρ_{c}=Density of continuous phase [kg/m³]
ρₑ=Density of ethanol [kg/m³]
ρ_{g}=Density of glycerol [kg/m³]
ρᵢ=Density of each species [kg/m³]
ρₚ=Particle density [kg/m³]
ρ_{w}=Density of water [kg/m³]
vₑ=Kinematic viscosity of ethanol [m²/s]
v=Kinematic viscosity of the aqueous ethanol-glycerol [m²/s]
v_{e/w}=Kinematic viscosity of the binary aqueous ethanol [m²/s]
v_{w}=Kinematic viscosity of water [m²/s]
τᵢ=Shear stress of species [N/m²]
\dot{γ}=Shear-rate [s⁻¹]
τᵢ^{t}=Turbulent shear stress of species [N/m²]
v_{c}^{t}=Turbulent kinematic viscosity of continuous phase [m²/s]
σ_{α}=Turbulent Prandtl number

The invention also provides a control system for a biofuels plant which includes a processor configured to calculate the production rate for ethanol substantially as defined above. The control system includes means for controlling at least some operations of the plant to achieve user determined ethanol production rates based on measurements made within the plant. Such a control system could be of conventional configuration and operation with the processor forming a “plug-in” or module thereto. It will be apparent to those skilled in the art that the processor need not stand alone from that of the control system but could be integral with that of the control system and be configured through software, or hardware, to perform the calculations for determining ethanol production.

The control system can be used to model the process in real time to simulate consequences and predict results based on actual process parameters. Before any steps are taken, the results can thus be predicted enabling the operator to make informed decisions. This can greatly assist in optimising the process.

It is envisaged that the control system will measure and control a plurality of unit operations within the plant with the goal of optimising ethanol production.

### Modelling

The numerical model used to configure the processor for simultaneous saccharification and fermentation of crystalline cellulose assumes the following pathway from substrate to product:

Endoglucanase and exoglucanase enzymes adsorb to the insoluble Avicel particle surface forming enzyme-substrate complexes [EC]_{endo} and [EC]ₑₓₒ. The rate of formation of these bonds is described by dynamic adsorption type equations which correlates adsorbed enzyme with the conversion rate of the substrate.

$$\frac{d {[ EC ]}_{endo}}{d t} = \frac{d {[ C ]}_{endo}}{d t} \times ( 1 + {σ}_{endo} ) + {k}_{fc} [ {E}_{f , endo} ] [ {C}_{f , endo} ] ( 1 + {σ}_{endo} ) - {\frac{{k}_{fc}}{{K}_{endo}} [ EC ]}_{endo}$$

$$\frac{d {[ EC ]}_{exo}}{d t} = \frac{d {[ C ]}_{exo}}{d t} \times ( 1 + {σ}_{exo} ) + {k}_{fc} [ {E}_{f , exo} ] [ {C}_{f , exo} ] ( 1 + {σ}_{exo} ) - {\frac{{k}_{fc}}{{K}_{exo}} [ EC ]}_{exo}$$

Where K_{endo} and Kₑₓₒ are adsorption affinity constants and the free enzymes [E_{f}] and free cellulose [C_{f}] are determined from

$$[ {E}_{f} ] = [ {E}_{T} ] - \frac{[ EC ] \times σ}{( 1 + σ )} \\ [ {C}_{f} ] = [ {C}_{T} ] - \frac{[ EC ]}{( 1 + σ )}$$

with σ being the maximum enzyme capacity of the substrate (g enzymes/g cellulose).

Hydrolysis of cellulose consisting of amorphous and crystalline structures is determined as a function of adsorbed enzyme [EC] to the substrate and the enzymes specific enzyme activity (k_{endo} or kₑₓₒ):

$$\frac{d {[ C ]}_{endo}}{d t} = - {k}_{endo} \times \frac{{[ EC ]}_{endo}}{1 + {σ}_{endo}} \times ( \frac{{K}_{C \_ Cb}}{[ Cb ] + {K}_{C \_ Cb}} ) \times ( \frac{{K}_{C \_ Eth}}{[ Eth ] + {K}_{C \_ Eth}} )$$

$$\frac{d {[ C ]}_{exo}}{d t} = tanh ( \frac{t}{τ} ) \times - {k}_{exo} \times \frac{{[ EC ]}_{exo}}{1 + {σ}_{exo}} \times ( \frac{{K}_{C \_ Cb}}{[ Cb ] + {K}_{C \_ Cb}} ) \times ( \frac{{K}_{C \_ Eth}}{[ Eth ] + {K}_{C \_ Eth}} )$$

Inhibition from cellobiose and ethanol are calculated with correlations from Phillippidis et al. (1992).

It is assumed that cellulose chains are converted to cellobiose by exoglucanase. This conversion of cellulose to cellobiose is modelled proportionally to the cellulose hydrolysis rate, whereas the conversion of cellobiose to glucose was modelled using Michaelis-Menten kinetics as described by Phillippidis et al. (1992).

$$\frac{d [ Cb ]}{d t} = - \frac{342}{324} \times \frac{d [ C ]}{d t} - \frac{{K}_{Cb} [ Cb ] [ B ]}{{K}_{m} \times ( 1 + \frac{[ G ]}{{K}_{Cb \_ G}} ) + [ Cb ]}$$

Hydrolysis of cellobiose to glucose by β-glucosidase and the glucose utilization by the yeast cells can be described by equation:

$$\frac{d [ G ]}{d t} = ( - \frac{342}{324} \times \frac{d [ C ]}{d t} - \frac{d [ Cb ]}{d t} ) \times \frac{360}{342} - \frac{1}{{Y}_{X \_ G}} \times \frac{d [ X ]}{d t}$$

The fermentation of glucose to ethanol, carbon dioxide and glycerol was modelled as an anaerobic batch process following the stoichiometric approximation that describes the catabolic conversion of glucose

C₆H₁₂O₆+0.2H₂→1.8(C₂H₆O+CO₂)+0.2C₃H₈O₃

The yeast growth rate and product production rate for ethanol, carbon dioxide and glycerol are thus described by:

$$\frac{d [ X ]}{d t} = \frac{{μ}_{ma x} [ X ] [ G ]}{[ G ] + {K}_{G}} \times ( 1 - \frac{[ Eth ]}{{K}_{X \_ Eth}} )$$

$$\frac{d [ Eth ]}{d t} = ( \frac{{Y}_{Eth \_ G}}{{X}_{X \_ G}} ) \times \frac{d [ X ]}{d t}$$

$$\frac{d [ {CO}_{2} ]}{d t} = ( \frac{{Y}_{CO 2 \_ G}}{{Y}_{X \_ G}} ) \times \frac{d [ X ]}{d t}$$

$$\frac{d [ Gly ]}{d t} = ( \frac{{Y}_{Gly \_ G}}{{Y}_{X \_ G}} ) \times \frac{d [ X ]}{d t}$$

The flow-field and particle properties and fermentation medium conditions can be modelled using the following set of equations which would be solved iteratively in a three-dimensional domain.

Continuity is maintained throughout the domain by ensuring the conservation of mass:

$$\frac{\partial }{\partial t} ( {α}_{i} {ρ}_{i} ) + ∇ \cdot ( {α}_{i} {ρ}_{i} {v}_{i} ) = 0$$

Navier-Stokes equation calculated the momentum of the different species in the domain:

$$\frac{\partial }{\partial t} ( {α}_{i} {ρ}_{i} {v}_{i} ) + ∇ \cdot ( {α}_{i} {ρ}_{i} {v}_{i} {v}_{i} ) = - {α}_{i} ∇ p + {α}_{i} {ρ}_{i} g + ∇ \cdot [ {α}_{i} ( {τ}_{i} + {τ}_{i}^{t} ) ] + {M}_{i}$$

Lift force (Auton, 1988) which acts upon the cellulose particles:

F_{L}═C_{L}αₛρ_{c}[vᵣ×(∇×vᵣ)]

Turbulent dispersion force which accounts for the effects of turbulence on the particle transportation.

$${F}_{c d}^{TD} = ( - {A}_{cs}^{D} ) \frac{{v}_{c}^{t}}{{σ}_{α}} ( \frac{∇ {α}_{s}}{{α}_{s}} - \frac{∇ {α}_{c}}{{α}_{c}} )$$

Solid pressure force limits the packing volume of the cellulose particles:

F_{i,s}=−101325{tan h[200(α_{max,s}−αₛ)]−1}∇αₛ

Particle drag force (Syamlal and O'brein, 1988) accounts for the interactions between the continuous phase and solid particles phases:

F_{cs}^{D}=A_{cs}^{D}(vₛ−v_{c})

with:

$${A}_{cs}^{D} = \frac{3 {α}_{c} {α}_{s} {ρ}_{c} {C}_{D}}{4 {V}_{rs}^{2} {D}_{eff}} \vert {v}_{r} \vert$$

$${V}_{rs} = 0.5 [ A - 0.06 {Re}_{s} + \sqrt{{( 0.06 {Re}_{s} )}^{2} + 0.21 {Re}_{s} ( 2 B - A ) + {A}^{2}} ]$$

$${Re}_{s} = \frac{{ρ}_{c} {v}_{r} {D}_{eff}}{{μ}_{c}}$$

$$A = {α}_{c}^{4.14}$$

$$B = \{ \begin{matrix}0.8 {α}_{c}^{1.28} ; & {α}_{c} < {α}_{tr} \\ {α}_{c}^{2.65} ; & {α}_{c} \geq {α}_{tr}\end{matrix}$$

### Drag Coefficient (White, 1991):

$${C}_{D} = \frac{24}{{Re}_{s }} + \frac{6}{1 + \sqrt{{Re}_{s}}} + 0.4$$

Viscosity of the fermentation medium based on the particle ethanol and glycerol concentrations:

μ_{eff}=(1−αₛ)μ₀+(αₛ)μₛ

### With (Moreira, 2009):

μ₀={v_{e/w}+a└exp(bx_{g})−1┘}p_{eff}

with

v_{e/w}=xₑvₑ+(1−xₑ)v_{w}+xₑ(1−xₑ)F_{T}

$${F}_{T} = [ \begin{matrix}exp ( \frac{3255}{T} - 9.41 ) + ( 1 - 2 {x}_{e} ) exp ( \frac{3917}{T} - 11.44 ) + \\ {( 1 - 2 {x}_{e} )}^{2} exp ( \frac{5113}{T} - 16.6 )\end{matrix} ]$$

$$a = - 1.39 + 5.64 exp ( \frac{273.1 - T}{62.03} ) + [ 3.56 - \frac{89.18}{{( T - 273.1 )}^{1.5}} ] {x}_{e} - 8.80 {x}_{e}^{2} + 5.91 {x}_{e}^{3}$$

$$b = 4.11 + 5.54 exp ( \frac{273.1 - T}{25.03} )$$

$${ρ}_{eff} = \frac{{m}_{w} \times {ρ}_{w} + {m}_{e} \times {ρ}_{e} + {m}_{g} \times {ρ}_{g}}{{m}_{total}}$$

$${μ}_{s} = K {\dot{γ}}^{n}$$

$$K = \{ \begin{matrix}\frac{201 ( {α}_{s} - 0.0125 )}{[ 1 + 49 ( {α}_{s} - 0.0125 ) ]} ; & for {α}_{s} > 0.0125 \\ 0 ; & for {α}_{s} \leq 0.0125\end{matrix} \\ n = - 2.764 {α}_{s} - 0.631$$

### Testing

### Glucose Fermentations

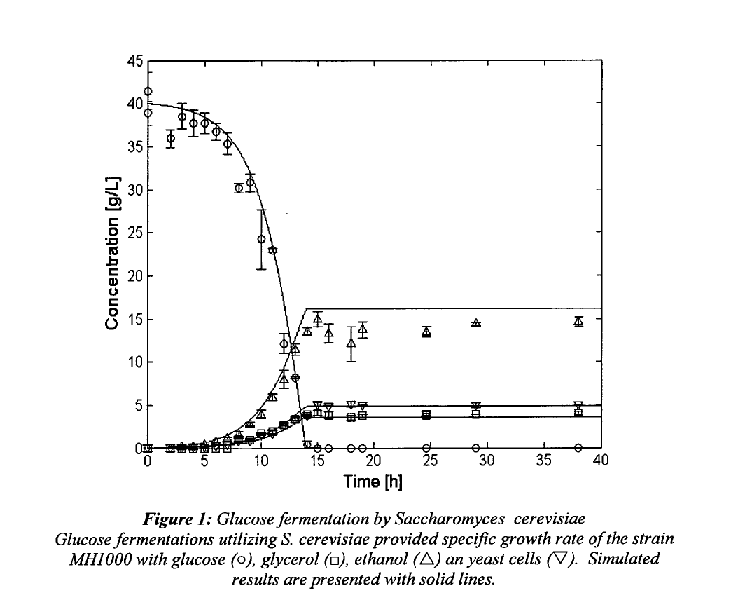

To verify the numerical model for S. cerevisiae, anoxic fermentations were conducted at a glucose concentration of 40 g/L (FIG. 1). The utilization and conversion of glucose by the yeast to form ethanol, glycerol and carbon dioxide was modelled assuming the stoichiometric approximation. The maximum growth rate (μₘₐₓ) for this organism was calculated to be 0.38 h⁻¹.

Measured ethanol concentrations reached approximately 14.6 g/L (75% of the theoretical maximum). The numerical model, however, calculated a final ethanol concentration of 16.19 g/L.

A carbon balance was performed on the experimental results which indicated that 96.36%±0.24% of the carbon from the glucose was found in the fermentation products and biomass.

Discrepancies between the calculated and experimental results of ethanol concentration may indicate that a small portion of the ethanol evaporated from the reactor during the course of the experiment. This may also be deduced from the incomplete carbon balance of 96.36%.

### Enzyme Activities

The enzyme activities and protein concentrations of Spezyme CP and Novozym 188 are summarised in Table 1.

TABLE 1

| Enzyme | FPU | CbU | Endoglucanase | Exoglucanase | β-glucosidase | Protein |
|---|---|---|---|---|---|---|
| Preparation | [U/mL] | [U/mL] | [IU/mL] | [IU/mL] | [IU/mL] | [mg/mL] |
| Spezyme^{CP} | 64.5 | N/A | 908.6 ± 90.5 | 1.447 ± 0.2 | 134.8 ± 3.9 | 195.4 ± 15.2 |
| Novozyme 188 | N/A | 586.2 | 20.9 | N/A | 724.2 ± 35.8 | 148.1 ± 7.4 |

These values were used to estimate the added enzyme component in the medium in which the conversion of crystalline insoluble cellulose to ethanol occurs. According to Goyal (1991), 80% of the protein in a mixture derived from T. reesei such as Spezyme CP was identified as exoglucanase, whereas 12% was found to be endoglucanase. Filter paper units (FPU) and cellobiose units (CbU) were used to standardise and correlate the enzyme loadings with values provided from the literature.

The total enzyme protein added to each reactor for a cellulase loading of 10 FPU/g cellulose and a β-glucosidase loading 50 CbU/g cellulose amounts to a total initial concentration of 0.39 g/L endoglucanase, 2.59 g/L exoglucanase and 1.35 g/L of β-glucosidase.

The determined enzyme preparation activities of the Spezyme CP compared favourably with values found from literature with Kumar and Wyman (2008) reporting values of 59 FPU/mL and 123 mg/mL protein, with the mixture used in this study measured to be 64.5 FPU/mL with a protein concentration of 195.4 mg/mL. 10 FPU/mL was selected based on common practise from literature. 50 CbU/ml β-glucosidase was added to the solution to ensure that no cellobiose would accumulate in the reactors, which would severely inhibit the hydrolysis of the Avicel.

### Enzymes Adsorption to Avicel

Avicel can be divided into two regions. One region is assumed to consist of long chains of cellulose with no exposed ends known as amorphous, which is randomly cut by the endoglucanase enzyme, creating new loose ends. Exoglucanase attaches to these ends and proceeds to hydrolyse the remaining densely packed crystalline chains into reduced sugars, primarily cellobiose. Both these regions are assumed to always be present in Avicel. An initial distribution of endoglucanase and exoglucanase binding sites was assumed as 55% and 45% respectively.

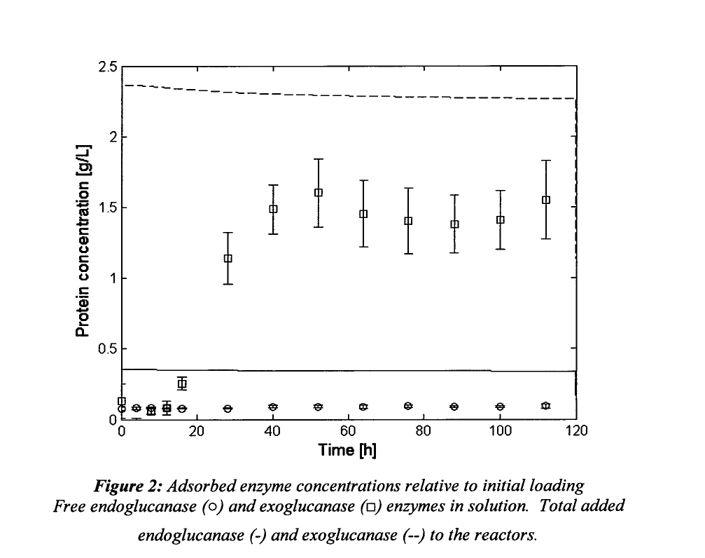

Adsorbed protein concentrations for endoglucanase and exoglucanase enzymes were calculated by subtracting the experimentally determined free enzyme concentrations in the broth from the theoretical total enzyme initially added (FIG. 2). Experimental measurements further indicated that negligible amounts of β-glucosidase were adsorbed.

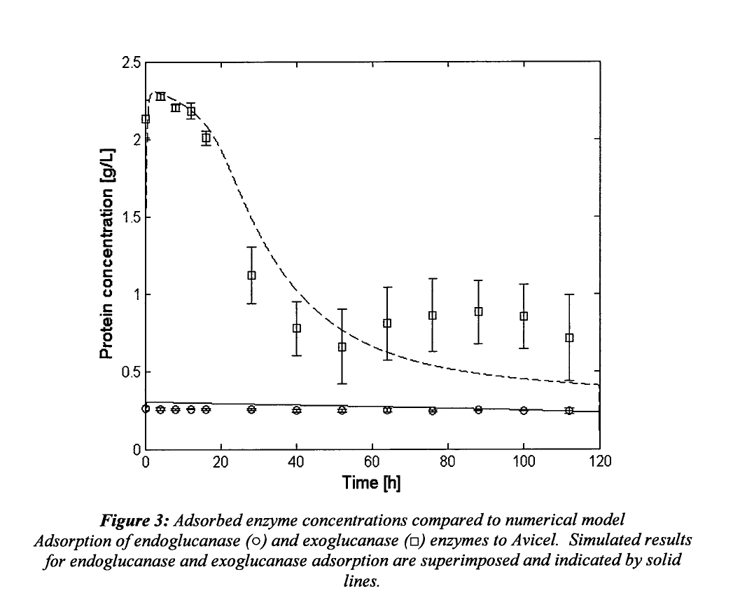

The calculated adsorbed enzymes concentrations (FIG. 3) indicates that adsorbed endoglucanase remained relatively consistent throughout the fermentation with adsorbed exoglucanase protein concentrations showing a considerable (5 fold) decrease from approximately 2.4 g/L to around 0.83 g/L after approximately 20 h (FIG. 2). Adsorption of endoglucanase and exoglucanase to Avicel was modelled using the dynamic adsorption models. With the assumed initial amorphous and crystalline constitution of Avicel, the models were capable of predicting the significant decrease in adsorbed exoglucanase. The model further correlates with the near constant adsorbed endoglucanase concentrations.

The adsorption models do not predict the apparent increase in adsorbed exoglucanase recorded after approximately 55 h. However, at a significance level of 5%, this apparent trend of increased adsorption is not statistically significant.

The adsorbed cellulases calculated from the difference in total and free cellulase in solution was compared with the predictions from the numerical model (FIG. 3). The adsorption model was capable of calculating the trends measured experimentally, but tends to under calculate the adsorbed exoglucanase concentrations during the later stages of the fermentation. The numerical model calculates the adsorbed endoglucanase concentrations reasonably well.

### SSF of Avicel

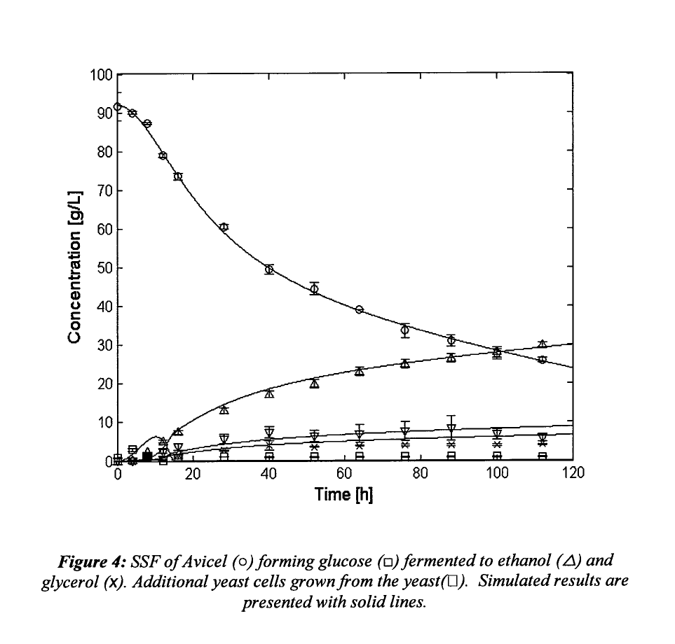

SSF of 100 g/L Avicel supplemented with Spezyme CP and Novozym 188 was conducted to verify the complete numerical model. Experimental results (FIG. 4) show that after 112 h, approximately 72.6% of the Avicel was converted. Furthermore, there appears to be a delay in the initial conversion of the Avicel (first 8 h) after which it is converted at a significantly higher rate. The numerical model does not predict this delay in enzymatic conversion and over predicts the glucose formed.

HPLC measurements indicated no trace of soluble cellobiose accumulation during the experiment, indicating that all cellulose was fully converted to glucose and fermented. The numerical model correctly predicts this rapid hydrolysis of cellobiose to glucose by β-glucosidase.

A small glucose peak of approximately 3 g/L was detected at approximately 4 h, thereafter rapidly decreasing to approximately 1 g/L for the remainder of the experiment. The numerical model calculates a glucose peak of 10.25 g/L at 7.4 h before the fermentation thereof the yeast decreases the concentration to 0 g/L.

Parameter fitting was performed on the remaining model constants for the SSF of Avicel. These values are presented in Table 2, with the specific hydrolyses rates k_{endo}, kₑₓₒ, equilibrium constant Kₑₓₒ, enzyme capacity σₑₓₒ and the yields Y_{CO2}_{_{—}}_{G}, Y_{Eth}_{_{—}}_{G} and Y_{Gly}_{_{—}}_{G} determined empirically.

TABLE 2

| Symbol | Value | | Source |
|---|---|---|---|
| K_{endo} | 0.110 | h⁻¹ | This Work |
| Kₑₓₒ | 0.07 | h⁻¹ | This Work |
| K_{endo} | 1.84 | L/g | Kumar and Wyman (2008) |
| Kₑₓₒ | 55 | L/g | This Work |
| k_{fc} | 1.8366 | L/(g · h) | Shao et al. (2008) |
| K_{C}_{_{—}}_{Cb} | 5.85 | g/L | Phillipidis et al. (1992) |
| K_{C}_{_{—}}_{Eth} | 50.35 | g/L | Phillipidis et al. (1992) |
| K_{Cb} | 0.02 | g/(U · h) | Gusakov and Sinitsyn (1985) |
| K_{Cb}_{_{—}}_{G} | 0.62 | g/L | Phillipidis et al. (1992) |
| K_{G} | 0.476 | g/L | Ghose and Tyagi (1979) |
| Kₘ | 10.56 | g/L | Phillipidis et al. (1992) |
| K_{X}_{_{—}}_{Eth} | 87 | g/L | Ghose and Tyagi (1979) |
| Y_{CO2}_{_{—}}_{G} | 0.4 | | This Work |
| Y_{Eth}_{_{—}}_{G} | 0.419 | | This Work |
| Y_{Gly}_{_{—}}_{G} | 0.091 | | This Work |
| Y_{X}_{_{—}}_{G} | 0.12 | | Ghose and Tyagi (1979) |
| μₘₐₓ | 0.4 | h⁻¹ | Ghose and Tyagi (1979) |
| σ_{endo} | 0.084 | | Kumar and Wyman (2008) |
| σₑₓₒ | 0.084 | | This Work |
| T | 8 | h | This Work |

The initial (<10 h) conversion rate of Avicel (FIG. 4) is found to be significantly lower than expected. The reason for this phenomenon is not clear and is not predicted by the numerical model. Possible explanations are that the enzymes are initially obstructed by other soluble constituents attached to the surface of the substrate which first needs to be cleared before the surface is significantly exposed for further adsorption. Once cleared, additional enzymes can attach and hydrolyze the cellulose causing the increase in conversion rate.

This initial delay in conversion rate measured experimentally explains the over prediction of the initial glucose peak (FIG. 4) calculated by the numerical model.

The specific cellulase activities for converting Avicel (k_{endo}, kₑₓₒ) along with the enzyme adsorption capacity (σₑₓₒ) and equilibrium constant (Kₑₓₒ) for exoglucanase were determined by parameter fitting from the numerical model.

### Particle Properties

The particle density of the microcrystalline cellulose particles were determined using Archimedes principle as ρ_{P}=1605.7 kg/m³ with a standard deviation of 56.3 kg/m³. Particles settling experiments revealed an average terminal velocity of approximately V_{P,term}=6.53×10⁻³ m/s with a standard deviation of 3.44×10⁻³ m/s.

The average effective particle diameter (D_{eff}) was determined as D_{eff}=1.41×10⁻⁴ m with a standard deviation of 1.02×10⁻⁴ m. Using the known properties of water at 21° C., with μ=9.83×10⁻⁴ kg/m·s and ρ_{w}=998 kg/m³ (çengel and Cimbala, 2006) along with D_{eff}=1.41×10⁻⁴ m, the Reynolds number was calculated as Re=0.9.

### Viscosity

The viscosity of the base medium displayed Newtonian fluid behaviour with an average viscosity of 8.64×10⁻⁴±1% kg/m·s. The reference viscosity of the RO water control was 8.31×10⁴ kg/m·s, indicating a 3.8% increase. This increase is primarily attributed to the presence of the 17.5 g/L (NH₄)₂SO₄ in solution.

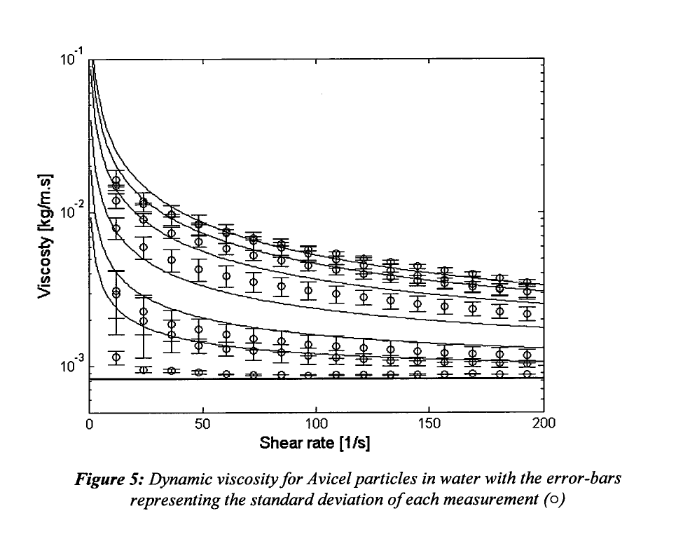

The Avicel particles effect on the viscosity proved most significant (FIG. 5). Particle concentrations of 100 g/L Avicel increased the viscosity to approximately 10⁻² kg/m·s decreasing with reduced concentrations as expected. The fluid viscosity with added particles displayed a shear-thinning effect in relation to the shear-rate (FIG. 5). Further investigation indicated that particle concentrations below 20 g/L had negligible effects on the viscosity of the medium and can be neglected.

The viscosity results from the oligosaccharides tests for both the Avicel particles in water and the hydrolysis experiments indicated no significant variation. The results from the Tween 80 test indicated no significant effect on the viscosity, except in the shear-rate range of 0 to 50 s⁻¹ where the average Tween 80 viscosity was 6%-26% lower than the control results.

Results for the ethanol and glycerol effects were calculated from equations 5 to 8 and found to increase the viscosity of the base medium to a maximum of 0.943×10⁻³ kg/m·s, with ethanol contributing the most significantly.

The contribution of the yeast cells to the viscosity of the medium proved negligible as the total volume fraction occupied by the cells was calculated as 2.52×10⁻³, which equated to a relative viscosity increase of 0.6%.

### Modelling

K and n variables were determined through the power-law regression methodology applied to the particle suspension viscosity measurements. The hyperbolic regression (Equation 33) best fitted the experimental values for K with a maximum error of 95% occurring at the concentration of 30 g/L (volume fraction of 0.0188) Avicel particles. The parameter fit for the n variable was linear (Equation 15) with a maximum error of 13%.

Applying the K and n numerical estimation parameters into equations 26 and 32, predictions for the effects of the particles on the dynamic viscosity (FIG. 5) displayed reasonable correlation with an average error of 11.1%. The largest error found in the final viscosity predictions was 26.4% found at the particle concentration of 30 g/L.

### CONCLUSION

Although there are inaccuracies with certain of the calculations of the numerical method, the overall calculated rate of ethanol production correlates well with the experimental results. The numerical model enables enzymatic hydrolysis of cellulose and other sugar polymers to be modelled with a more direct methodology overcoming the limitation of curve fitting reaction rates to fit cellulose conversion models of the prior art.

It will be appreciated that the numerical model can be applied to many other enzymatic hydrolysis and fermentation processes of cellulose, hemicellulose and xylan in combination with fermenting bacteria, yeasts, and fungal organisms to form various products including, ethanol, glycerol, acetic acid. Also, the cellulase enzymes may be native or recombinant exoglucanases, endoglucanases and β-glucosidases from fungal or bacterial sources with minor adaptations to the mathematical method. The mathematical formulas, or subsets of these, can be applied to enzymes active of hemicellulose (cellulose, xylan, mannan and galactans and derivates thereof), glucans, fructans, pectins and other carbohydrates available from plant biomass.

The microorganisms used for conversion of sugars to ethanol can be Saccharomyces cerevisiae MH1000 and can also be native or recombinant strains belonging to the genera Saccharomyces, Kluyveromyces, Candida, Pichia, Schizosaccharomyces, Hansenula, Kloeckera, Schwanniomyces, and Yarrowia. Particularly preferred yeast species as host cells include S. cerevisiae, S. bulderi, S. bametti, S. exiguus, S. uvarum, S. diastaticus, S. carlsbergensis, K. lactis, K. marxianus, and K. fragilis.

The microorganisms used for conversion of sugars to a variety of organic products can be native or recombinant strains of a variety of bacteria, yeasts and fungi currently in use for the production of commercially important products from simple sugar streams.

It will further be appreciated that any suitable processor can be used and that the processor can be configured in any suitable manner, including through software or hardware.

### REFERENCES

Albers E, Larsson C, Lidén G, Niklasson C, Gustafsson L. 2002. Continuous estimation of product concentration with calorimetry and gas analysis during anaerobic fermentations of Saccharomyces cerevisiae. Thermochimica Acta 394:185-190.
Auton T R, Hunt J C R, and Prud'homme M, 1988, The force exerted on a body in inviscid unsteady non-uniform rotational flow, Journal of Fluid Mechanics, 197:241-257.
Caminal G, López-Satin J, Solà C. 1984. Kinetic modeling of the enzymatic hydrolysis of pretreated cellulose. Biotechnology and Bioengineering. 27: 1282-1290.
çengel Y. A. and Cimbala J. M. 2006. Fluid mechanics: fundamentals and applications. McGraw-Hill. New York.
Converse A O, Matsuno R, Tanaka M, Taniguchi M. 1988. A model of enzyme adsorption and hydrolysis of microcrystalline cellulose with slow deactivation of the adsorbed enzyme. Biotechnology and Bioengineering 32:38-45.
Converse A O, Optekar J D. 1993. A synergistic kinetics model for enzymatic cellulose hydrolysis compared to the degree-of-synergism experimental results. Biotechnology and Bioengineering 42:145-148.
Ghose T K, Tyagi R D. 1979. Rapid ethanol fermentation of cellulose hydrolysate. II. Product and substrate inhibition and optimization of fermentor design. Biotechnology and Bioengineering. 21: 1401-1420.
Goyal A, Ghosh B, Eveleigh D. 1991. Characteristics of fungal cellulases. Bioresource Technology 36:37-50.
Gusakov A V, Sinitsyn A P. 1985. Kinetics of the enzymatic hydrolysis of cellulose: 1. A mathematical model for a batch reactor process. Enzyme and Microbial Technology 7:346-352.
Kumar R, Wyman C E. 2008. An improved method to directly estimate cellulase adsorption on biomass solids. Enzyme and Microbial Technology 42:426-433.
Lee Y, Fan L T. 1982. Kinetic studies of enzymatic hydrolysis of insoluble cellulose: analysis of the intial rates. Biotechnology and Bioengineering. 24: 2383-2406.
Moreira, R, Chenlo, F and LeGall, D. 2009. Kinematic viscosity and refractive index of aqueous solutions of ethanol and glycerol. Industrial & Engineering Chemistry Research. 48:2157-2161.
Phillippidis G P, Smith T K, Wyman C E. 1992. Study of the enzymatic hydrolysis of cellulose for production of fuel ethanol by the simultaneous saccharification and fermentation process. Biotechnology and Bioengineering 41:846-853.
Scheiding W, Thoma M, Ross A, Schügerl K. 1984. Modelling of the enzymatic hydrolysis of cellobiose and cellulose by a complex enzyme mixture of Trichoderma reesei QM 9414. Applied Microbiology and Biotechnology 20:176-182.
Shao X, Lynd L R, Wyman C E, Bakker A. 2008. Kinetic modeling of cellulosic biomass to ethanol via simultaneous saccharification and fermentation: Part I. Accommodation of intermittent feeding and analysis of staged reactors. Biotechnology and Bioengineering 102:59-65.
South C R, Hogsett D A L, Lynd L R. 1995. Modeling simultaneous saccharification and fermentation of lignocellulose to ethanol in batch and continuous reactors. Enzyme and Microbial Technology 17:797-803.
Syamlal, M., O'Brien, T. J. 1988. Simulation of granular layer inversion in liquid fluidized beds. International Journal of Multiphase Flow. 14(4):473-481.
White F. 1991. Viscous fluid flow. McGraw-Hill International Editions. Singapore.
Zhang J, Shao X, Townsend O V, Lynd L R. 2009. Simultaneous saccharification and co-fermentation of paper sludge to ethanol by Saccharomyces cerevisiae RWB222-Part 1: Kinetic modeling and parameters. Biotechnology and Bioengineering. 104:920-931.

1. A system for modelling the conversion of crystalline insoluble cellulose to ethanol which includes a processor configured to calculate the production rate for ethanol based on the following inputs:
Yeast cell concentration [g/L]-([X])
Cellulose concentration [g/L]-([C])
Cellobiose concentration [g/L]-([Cb])
Exo-cellulase enzyme concentration [g/L]-([Eₑₓₒ])
Endo-cellulase enzyme concentration [g/L]-([E_{endo}])
β-Glucosidase concentration [g/L]-([B])
Cellulose-enzyme complex concentration [g/L]-([EC]ₑₓₒ)
Cellulose-enzyme complex concentration [g/L]-([EC]_{endo})
Ethanol concentration [g/L]-([Eth])
Glucose concentration [g/L]-([G])
and as a function of the following equations:
$$\begin{matrix} [ {E}_{f} ] = [ {E}_{T} ] - \frac{[ EC ] \times σ}{( 1 + σ )} & ( 1 ) \\ [ {C}_{f} ] = [ {C}_{T} ] - \frac{[ EC ]}{( 1 + σ )} & ( 2 ) \\ \frac{d {[ EC ]}_{endo}}{d t} = \frac{d {[ C ]}_{endo}}{d t} \times ( 1 + {σ}_{endo} ) + {k}_{fc} [ {E}_{f , endo} ] [ {C}_{f , endo} ] - {\frac{{k}_{fc}}{{K}_{endo}} [ EC ]}_{endo} & ( 3 ) \\ \frac{d {[ EC ]}_{exo}}{d t} = \frac{d {[ C ]}_{exo}}{d t} \times ( 1 + {σ}_{exo} ) + {k}_{fc} [ {E}_{f , exo} ] [ {C}_{f , endo} ] ( 1 + {σ}_{exo} ) - {\frac{{k}_{fc}}{{K}_{exo}} [ EC ]}_{exo} & ( 4 ) \\ \frac{d {[ C ]}_{endo}}{d t} = - {k}_{endo} \times \frac{{[ EC ]}_{endo}}{1 + {σ}_{endo}} \times ( \frac{{K}_{C \_ Cb}}{[ Cb ] + {K}_{C \_ Cb}} ) \times ( \frac{{K}_{C \_ Eth}}{[ Eth ] + {K}_{C \_ Eth}} ) & ( 5 ) \\ \frac{d {[ C ]}_{exo}}{d t} = tanh ( \frac{t}{τ} ) \times - {k}_{exo} \times \frac{{[ EC ]}_{exo}}{1 + {σ}_{exo}} \times ( \frac{{K}_{C \_ Cb}}{[ Cb ] + {K}_{C \_ Cb}} ) \times ( \frac{{K}_{C \_ E th}}{[ Eth ] + {K}_{C \_ Eth}} ) & ( 6 ) \\ \frac{d [ Cb ]}{d t} = - \frac{342}{324} \times \frac{d [ C ]}{d t} - \frac{{K}_{Cb} [ Cb ] [ B ]}{{K}_{m} \times ( 1 + \frac{[ G ]}{{K}_{C b \_ G}} ) + [ Cb ]} & ( 7 ) \\ \frac{d [ G ]}{d t} = ( - \frac{342}{324} \times \frac{d [ C ]}{d t} - \frac{d [ Cb ]}{d t} ) \times \frac{360}{342} - \frac{1}{{Y}_{X \_ G}} \times \frac{d [ X ]}{d t} & ( 8 ) \\ \frac{d [ X ]}{d t} = \frac{{μ}_{ma x} [ X ] [ G ]}{[ G ] + {K}_{G}} \times ( 1 - \frac{[ Eth ]}{{K}_{X \_ Eth}} ) & ( 9 ) \\ \frac{d [ Eth ]}{d t} = ( \frac{{Y}_{Eth \_ G}}{{Y}_{X \_ G}} ) \times \frac{d [ X ]}{d t} & ( 10 )\end{matrix}$$
where:
K_{C}_{_{—}}_{Cb}=Inhibition constant of cellobiose on cellulose conversion [g/L]
K_{C}_{_{—}}_{Eth}=Inhibition constant of ethanol on cellulose conversion [g/L]
K_{Cb}=Rate constant for hydrolysis of cellobiose to glucose [g/L]
K_{Cb}_{_{—}}_{G}=Inhibition of hydrolysis of cellobiose by glucose [g/L]
K_{endo}=Equilibrium constant for endoglucanase [L/g]
k_{endo}=Hydrolysis rate constant of endoglucanase [h⁻¹]
Kₑₓₒ=Equilibrium constant for exoglucanase [L/g]
kₑₓₒ=Hydrolysis rate constant of exoglucanase [h⁻¹]
k_{fc}=Enzyme adsorption constant to Avicel [h⁻¹]
K_{G}=Monod constant [g/L]
Kₘ=Michaelis constant of β-glucosidase for cellobiose [g/L]
K_{X}_{_{—}}_{Eth}=Inhibition of cell growth by ethanol [g/L]
Y_{Eth}_{_{—}}_{G}=Yield of ethanol cells per gram of glucose
Y_{X}_{_{—}}_{G}=Yield of yeast cells per gram of glucose
μₘₐₓ=Maximum growth rate of yeast cells [h⁻¹]
σ_{endo}=Endoglucanse enzyme capacity on Avicel [dimensionless]
σₑₓₒ=Exoglucanase enzyme capacity on Avicel [dimensionless]
T=Time Constant [h].

2. A system as claimed in claim 1 wherein the calculated production rate for ethanol is used to adjust process parameters.

3. A system as claimed in claim 1 wherein the processor solves the equations (1) to (10) iteratively.

4. A system as claimed in claim 1 wherein the processor has a feedback loop which includes the further input of a measured rate of formation of enzyme-substrate complexes.

5. A system as claimed in claim 1 wherein a still further input to the processor of supplied oxygen is provided.

6. A system as claimed in claim 1 wherein the processor calculates the production rates of carbon dioxide and glycerol based on the following inputs:
Carbon Dioxide concentration [g/L]-([CO₂])
Glycerol concentration [g/L]-([Gly])
and as a function of the following equations:
$$\begin{matrix}\frac{d [ {CO}_{2} ]}{d t} = ( \frac{{Y}_{CO 2 \_ G}}{{Y}_{X \_ G}} ) \times \frac{d [ X ]}{d t} & ( 11 ) \\ \frac{d [ Gly ]}{d t} = ( \frac{{Y}_{Gly \_ G}}{{Y}_{X \_ G}} ) \times \frac{d [ X ]}{d t} & ( 12 )\end{matrix}$$
where:
Y_{CO2}_{_{—}}_{G}=Yield of ethanol cells per gram of glucose.
Y_{Gly}_{_{—}}_{G}=Yield of ethanol cells per gram of glucose.

7. A system as claimed in claim 1 wherein the processor calculates the rheological properties of a medium in which the conversion of crystalline insoluble cellulose to ethanol occurs, including drag, shear rates and wall shear stress based on the following inputs:
Drag Coefficient [Dimensionless]-(C_{D})
Lift coefficient [Dimensionless]-(C_{L})
Effective diameter of the particles [m]-(D_{eff})
Gravitational constant [m/s²]-(g)
Viscosity variable as a function of volume fraction [kg/m·s⁽¹⁻ⁿ⁾]-(K)
Mass of the ethanol component [kg]-(mₑ)
Mass of the glycerol component [kg]-(m_{g})
Total mass of the solution [kg]-(mₜₒₜₐₗ)
Mass of the water component [kg]-(m_{w})
Viscosity power variable as a function of volume fraction-(n)
Absolute temperature [K]-(T)
Molar fraction of ethanol-(xₑ)
Molar fraction of glycerol-(x_{g})
Molar fraction of water-(x_{w})
Volume fraction of the continuous phase-(α_{c})
Volume fraction of the cellulose particles-(αₛ)
Dynamic viscosity of mixture [kg/m·s]-(μ_{eff})
Base dynamic viscosity of the fluid [kg/m·s]-(μₒ)
Dynamic viscosity of base medium [kg/m·s]-(μ_{b})
Continuous medium density [kg/m³]-(ρ_{eff})
Particle density [kg/m³]-(ρₛ)
and as a function of the following equations:
$$\begin{matrix} \frac{\partial }{\partial t} ( {α}_{i} {ρ}_{i} ) + ∇ \cdot ( {α}_{i} {ρ}_{i} {v}_{i} ) = 0 & ( 13 ) \\ \frac{\partial }{\partial t} ( {α}_{i} {ρ}_{i} {v}_{i} ) + ∇ \cdot ( {α}_{i} {ρ}_{i} {v}_{i} {v}_{i} ) = - {α}_{i} ∇ p + {α}_{i} {ρ}_{i} g + ∇ \cdot [ {α}_{i} ( {τ}_{i} + {τ}_{i}^{t} ) ] + {M}_{i} & ( 14 ) \\ {F}_{L} = {C}_{L} {α}_{s} {ρ}_{c} [ {v}_{s} \times ( ∇ \times {v}_{c} ) ] & ( 15 ) \\ {F}_{c d}^{TD} = ( - {A}_{es}^{D} ) \frac{{v}_{c}^{t}}{{σ}_{u}} ( \frac{∇ {α}_{s}}{{α}_{s}} - \frac{∇ {α}_{c}}{{α}_{c }} ) & ( 16 ) \\ {F}_{i , s} = - 101325 \{ tanh [ 200 ( {α}_{m ax , s} - {α}_{s} ) ] - 1 \} ∇ {α}_{s} & ( 17 ) \\ {F}_{cs}^{D} = {A}_{cs}^{D} ( {v}_{s} - {v}_{c} ) \\ with \text{:} & ( 18 ) \\ {A}_{cs}^{D} = \frac{3 {α}_{c} {α}_{s} {ρ}_{c} {C}_{D}}{4 {V}_{rs}^{2} {D}_{eff }} \vert {v}_{t} \vert & ( 19 ) \\ {V}_{ts} = 0.5 [ A - 0.06 {Re}_{s} + \sqrt{{( 0.06 {Re}_{s} )}^{2} + 0.12 {Re}_{s} ( 2 B - A ) + {A}^{2}} ] & ( 20 ) \\ {Re}_{s} = \frac{{ρ}_{c} {v}_{f} {D}_{eff}}{{μ}_{c}} & ( 21 ) \\ A = {α}_{c}^{4.14} & ( 22 ) \\ B = \{ \begin{matrix}0.8 {α}_{c}^{1.28} ; & {α}_{c} < {α}_{u} \\ {α}_{c}^{2.65} ; & {α}_{c} \geq {α}_{u}\end{matrix} & ( 23 ) \\ {C}_{D} = \frac{24}{{Re}_{s}} + \frac{6}{1 + \sqrt{{Re}_{s}}} + 0.4 \\ and & ( 24 ) \\ {μ}_{eff} = ( 1 - {α}_{s} ) {μ}_{0} + ( {α}_{s} ) {μ}_{s} \\ with \text{:} & ( 25 ) \\ {μ}_{0} = \{ {v}_{c / w} + a ⌊ exp ( {bx}_{g} ) - 1 ⌋ \} {ρ}_{eff} \\ with & ( 26 ) \\ {v}_{c / w} = {x}_{c} {v}_{c} + ( 1 - {x}_{c} ) {v}_{w} + {x}_{c} ( 1 - {x}_{u} ) {F}_{T} & ( 27 ) \\ {F}_{T} = [ \begin{matrix}exp ( \frac{3255}{T} - 9.41 ) + ( 1 - 2 {x}_{e} ) exp ( \frac{3917}{T} - 11.44 ) + \\ {( 1 - {x}_{e} )}^{2} exp ( \frac{5113}{T} - 16.6 )\end{matrix} ] & ( 28 ) \\ a = - 1.39 + 5.64 exp ( \frac{273.1 - T}{62.03} ) + [ 3.56 - \frac{89.18}{{( T - 273.1 )}^{1.3}} ] {x}_{e} - 8.80 {x}_{e}^{2} + 5.91 {x}_{e}^{3} & ( 29 ) \\ b = 4.11 + 5.54 exp ( \frac{273.1 - T}{25.03} ) & ( 30 ) \\ {ρ}_{eff} = \frac{{m}_{w} \times {ρ}_{w} + {m}_{e} \times {ρ}_{e} + {m}_{g} \times {ρ}_{G}}{{m}_{total}} & ( 31 ) \\ {μ}_{s} = K {\dot{γ}}^{n} & ( 32 ) \\ K = \{ \begin{matrix}\frac{201 ( {α}_{s} - 0.0125 )}{[ 1 + 49 ( {α}_{s} - 0.0125 )} ; & for {α}_{s} > 0.0125 \\ 0 ; & for {α}_{s} \leq 0.0125\end{matrix} & ( 33 ) \\ n = - 2.764 {α}_{s} - 0.631 & ( 34 )\end{matrix}$$
where:
F_{cs}^{D}=Drag Force [N/m³]
Mᵢ=Source terms [N/m³]
p=Pressure [Pa]
Reₛ=Reynolds number
V_{P,term}=Terminal settling velocity of the particles [m/s]
v_{c}=Velocity vector of the continuous phase [m/s]
v_{f}=Velocity vector of species [m/s]
vᵣ=Relative velocity vector [m/s]
vₛ=Velocity vector of the solids [m/s]
α_{c}=Volume fraction of the continuous phase
αᵢ=Volume fraction of the species
αₛ=Volume fraction of the cellulose particles
αₜᵣ=Volume fraction at which drag model transition occurs
μ=Dynamic viscosity of mixture [kg/m·s]
μₒ=Base dynamic viscosity of the fluid [kg/m·s]
μₛ=Dynamic viscosity adjustment for solids concentration [kg/m·s]
ρ_{c}=Density of continuous phase [kg/m³]
ρₑ=Density of ethanol [kg/m³]
ρ_{g}=Density of glycerol [kg/m³]
ρᵢ=Density of each species [kg/m³]
ρₚ=Particle density [kg/m³]
ρ_{w}=Density of water [kg/m³]
v_{c}=Kinematic viscosity of ethanol [m²/s]
v=Kinematic viscosity of the aqueous ethanol-glycerol [m²/s]
v_{e/w}=Kinematic viscosity of the binary aqueous ethanol [m²/s]
v_{w}=Kinematic viscosity of water [m²/s]
τᵢ=Shear stress of species [N/m²]
\dot{γ}=Shear-rate [s⁻¹]
τᵢ^{t}=Turbulent shear stress of species [N/m²]
v_{c}^{t}=Turbulent kinematic viscosity of continuous phase [m²/s]
σ_{α}=Turbulent Prandtl number.

8. A control system for a biofuels plant characterized in that it includes a processor substantially as claimed in claim 1 and which further includes means for controlling at least some operations of the plant to achieve user determined ethanol production rates based on measurements made within the plant.

9. A method of calculating the production rate of ethanol in a process which converts crystalline insoluble cellulose to ethanol, which includes iteratively solving the following equations:
$$\begin{matrix} [ {E}_{f} ] = [ {E}_{T} ] - \frac{[ EC ] \times σ}{( 1 + σ )} & ( 1 ) \\ [ {C}_{f} ] = [ {C}_{T} ] - \frac{[ EC ]}{( 1 + σ )} & ( 2 ) \\ \frac{d {[ EC ]}_{endo}}{d t} = \frac{d {[ C ]}_{endo}}{d t} \times ( 1 + {σ}_{endo} ) + {k}_{fc} [ {E}_{f , endo} ] [ {C}_{f , endo} ] ( 1 + {σ}_{endo} ) - {\frac{{k}_{f c}}{{K}_{endo}} [ EC ]}_{endo} & ( 3 ) \\ \frac{d {[ EC ]}_{exo}}{d t} = \frac{d {[ C ]}_{exo}}{d t} \times ( 1 + {σ}_{exo} ) + {k}_{fc} [ {E}_{f , exo} ] [ {C}_{f , exo} ] ( 1 + {σ}_{exo} ) - {\frac{{k}_{fc}}{{K}_{exo}} [ EC ]}_{exo} & ( 4 ) \\ \frac{d {[ C ]}_{endo}}{d t} = - {k}_{endo} \times \frac{{[ EC ]}_{endo}}{1 + {σ}_{endo}} \times ( \frac{{K}_{C \_ Cb}}{[ Cb ] + {K}_{C \_ Cb}} ) \times ( \frac{{K}_{C \_ Eth}}{[ Eth ] + {K}_{C \_ Eth}} ) & ( 5 ) \\ \frac{d {[ C ]}_{exo}}{d t} = tanh ( \frac{t}{τ} ) \times - {k}_{exo} \times \frac{{[ EC ]}_{exo}}{1 + {σ}_{exo}} \times ( \frac{{K}_{C \_ Cb}}{[ Cb ] + {K}_{C \_ Cb}} ) \times ( \frac{{K}_{C \_ Eth}}{[ Eth ] + {K}_{C \_ Eth}} ) & ( 6 ) \\ \frac{d [ Cb ]}{d t} = - \frac{342}{324} \times \frac{d [ C ]}{d t} - \frac{{K}_{Cb} [ Cb ] [ B ]}{{K}_{m} \times ( 1 + \frac{[ G ]}{{K}_{C b \_ G}} ) + [ Cb ]} & ( 7 ) \\ \frac{d [ G ]}{d t} = ( - \frac{342}{324} \times \frac{d [ C ]}{d t} - \frac{d [ Cb ]}{d t} ) \times \frac{360}{342} - \frac{1}{{Y}_{X \_ G}} \times \frac{d [ X ]}{d t} & ( 8 ) \\ \frac{d [ X ]}{d t} = \frac{{μ}_{ma x} [ X ] [ G ]}{[ G ] + {K}_{G }} \times ( 1 - \frac{[ Eth ]}{{K}_{X \_ Eth}} ) & ( 9 ) \\ \frac{d [ Eth ]}{d t} = ( \frac{{Y}_{E th \_ G}}{{Y}_{X \_ G}} ) \times \frac{d [ X ]}{d t} & ( 10 )\end{matrix}$$
where:
K_{C}_{_{—}}_{Cb}=Inhibition constant of cellobiose on cellulose conversion [g/L]
K_{C}_{_{—}}_{Eth} inhibition constant of ethanol on cellulose conversion [g/L]
K_{Cb}=Rate constant for hydrolysis of cellobiose to glucose [g/L]
K_{Cb}_{_{—}}_{G}=Inhibition of hydrolysis of cellobiose by glucose [g/L]
K_{endo}=Equilibrium constant for endoglucanase [L/g]
k_{endo}=Hydrolysis rate constant of endoglucanase [h⁻¹]
Kₑₓₒ=Equilibrium constant for exoglucanase [L/g]
kₑₓₒ=Hydrolysis rate constant of exoglucanase [h⁻¹]
k_{fc}=Enzyme adsorption constant to Avicel [h⁻¹]
K_{G}=Monod constant [g/L]
Kₘ=Michaelis constant of β-glucosidase for cellobiose [g/L]
K_{X}_{_{—}}_{Eth}=Inhibition of cell growth by ethanol [g/L]
Y_{Eth}_{_{—}}_{G}=Yield of ethanol cells per gram of glucose
Y_{X}_{_{—}}_{G}=Yield of yeast cells per gram of glucose
μₘₐₓ=Maximum growth rate of yeast cells [h⁻¹]
σ_{endo}=Endoglucanse enzyme capacity on Avicel [dimensionless]
σₑₓₒ=Exoglucanase enzyme capacity on Avicel [dimensionless]
T=Time Constant [h]
based on measurements of the following variables:
Yeast cell concentration [g/L]-([X])
Cellulose concentration [g/L]-([C])
Cellobiose concentration [g/L]-([Cb])
Exo-cellulase enzyme concentration [g/L]-([Eₑₓₒ])
Endo-cellulase enzyme concentration [g/L]-([E_{endo}])
β-Glucosidase concentration [g/L]-([B])
Cellulose-enzyme complex concentration [g/L]-([EC]ₑₓₒ)
Cellulose-enzyme complex concentration [g/L]-([EC]_{endo})
Ethanol concentration [g/L]-([Eth])
Glucose concentration [g/L]-([G]).

10. A method as claimed in claim 9 wherein the production rate of glycerol and carbon dioxide are simultaneously calculated as a function of the following equations:
Carbon Dioxide concentration [g/L]-([CO₂])
Glycerol concentration [g/L]-([Gly])
$$\begin{matrix}\frac{d [ {CO}_{2} ]}{d t} = ( \frac{{Y}_{CO 2 \_ G}}{{Y}_{X \_ G}} ) \times \frac{d [ X ]}{d t} & ( 11 ) \\ \frac{d [ Gly ]}{d t} = ( \frac{{Y}_{Gly \_ G}}{{Y}_{ X \_ G}} ) \times \frac{d [ X ]}{d t} & ( 12 )\end{matrix}$$
where:
Y_{CO2}_{_{—}}_{G}=Yield of ethanol cells per gram of glucose
Y_{Gly}_{_{—}}_{G}=Yield of ethanol cells per gram of glucose.
